(19) United States
(12) Patent Application Publication
(10) Pub. No.: US 2024/0184476 A1
(43) Pub. Date: Jun. 6, 2024

(54) NON-DISRUPTIVE MEMORY MIGRATION

(71) Applicant: Rambus Inc., San Jose, CA (US)

(72) Inventors: Danny MOORE, Vancouver (CA); Taeksang Song, San Jose, CA (US)

(21) Appl. No.: 18/519,345

(22) Filed: Nov. 27, 2023

Related U.S. Application Data
(60) Provisional application No. 63/430,132, filed on Dec. 5, 2022.

(51) Int. Cl. G06F 3/06

(52) U.S. Cl. CPC G06F 3/065; G06F 3/0611; G06F 3/064; G06F 3/0683

(57) ABSTRACT

A memory pool controller accesses multiple tiers of memory. Characteristics that sort memory into tiers may include, for example, slow/fast/fastest, longer-latency/shorter-latency, local/remote, compressed/uncompressed, bandwidth, jitter, capacity, and persistence, or a combination thereof. The controller may select and migrate blocks of data (e.g., pages) from one tier of memory to another. The controller uses a pointer during blocks migrations to allow applications to access migrating blocks without stopping the running workload. The controller also monitors the access frequency of blocks so that less frequently accessed blocks may be selected for migration to lower performance tiers of memory and more frequently accessed blocks migrated to higher performance tiers.

### BRIEF DESCRIPTION OF THE DRAWINGS

FIGS. 1A-1D are block diagrams illustrating a processing system having non-disruptive memory migration.

FIG. 2 is a flowchart illustrating a method of operating a controller.

FIG. 3 is a flowchart illustrating a method of migrating data.

FIG. 4 is a flowchart illustrating a page migration method.

FIG. 5 is a flowchart illustrating a method of processing write requests.

FIG. 6 is a flowchart illustrating a method of processing read requests.

FIG. 7 is a notional diagram illustrating memory being migrated.

FIG. 8 is a block diagram of a processing system.

### DETAILED DESCRIPTION OF THE EMBODIMENTS

In embodiment, a memory pool controller accesses multiple tiers of memory. Characteristics that sort memory into tiers may include, for example, slow/fast/fastest, longer-latency/shorter-latency, local/remote, compressed/uncompressed, bandwidth, jitter, capacity, and persistence, or a combination thereof. The controller may select and migrate blocks of data (e.g., pages) from one tier of memory to another. The controller uses a pointer or counter of a progress checker during block migrations to allow applications to access migrating blocks without stalling the running workload. In an embodiment, the controller also monitors the access frequency of blocks so that less frequently accessed blocks may be selected for migration to lower performance tiers of memory and more frequently accessed blocks migrated to higher performance tiers.

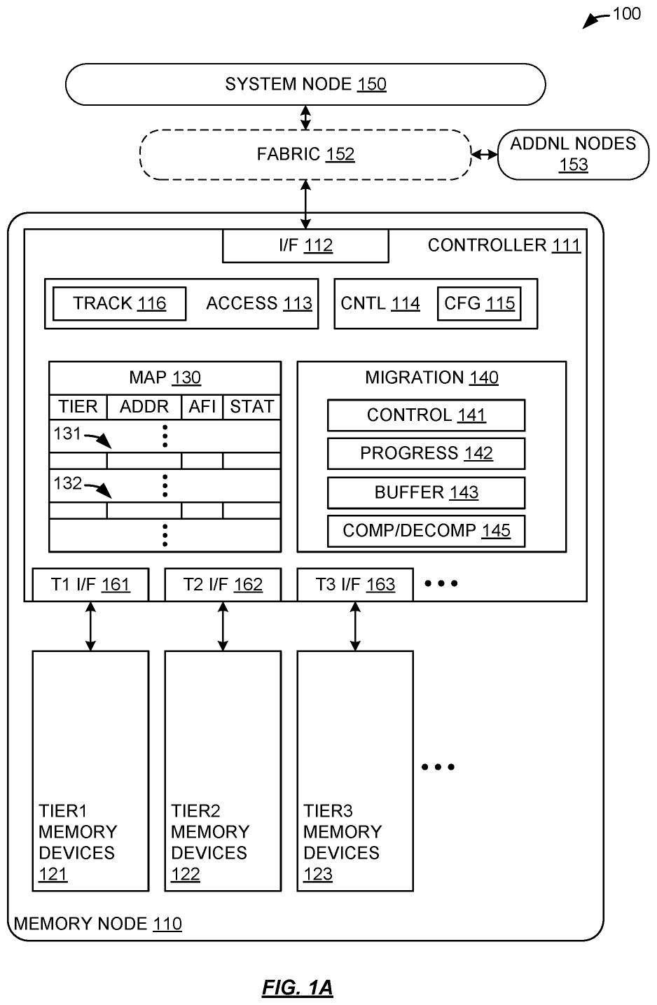

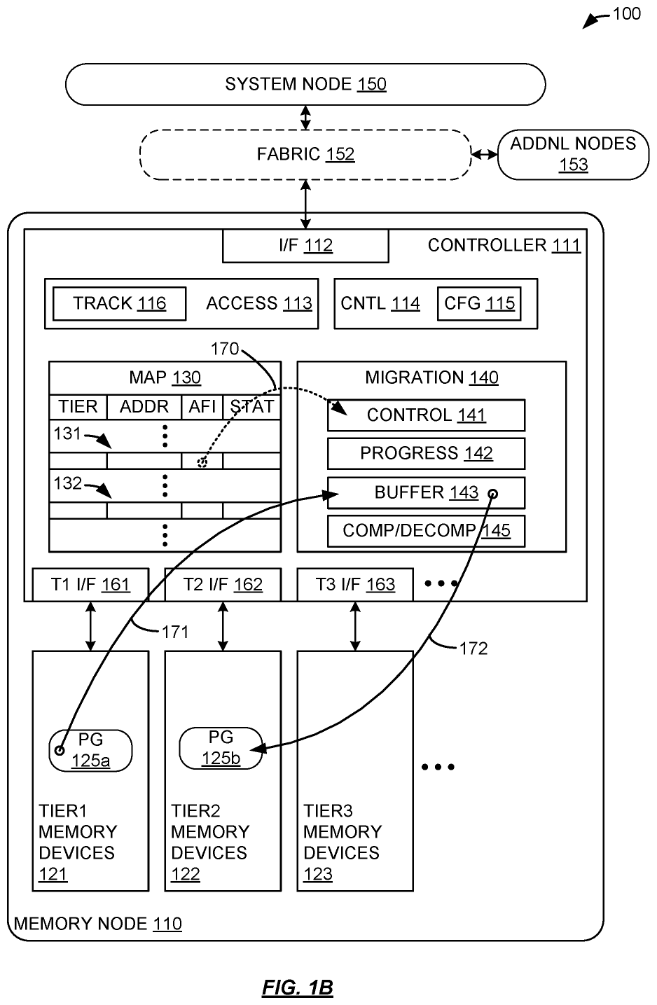

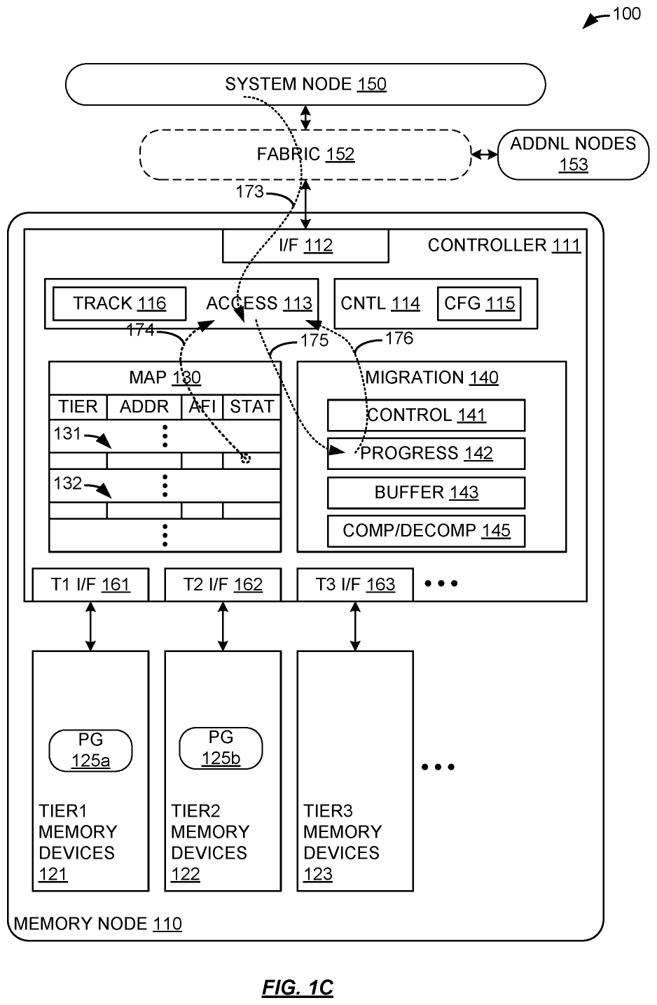

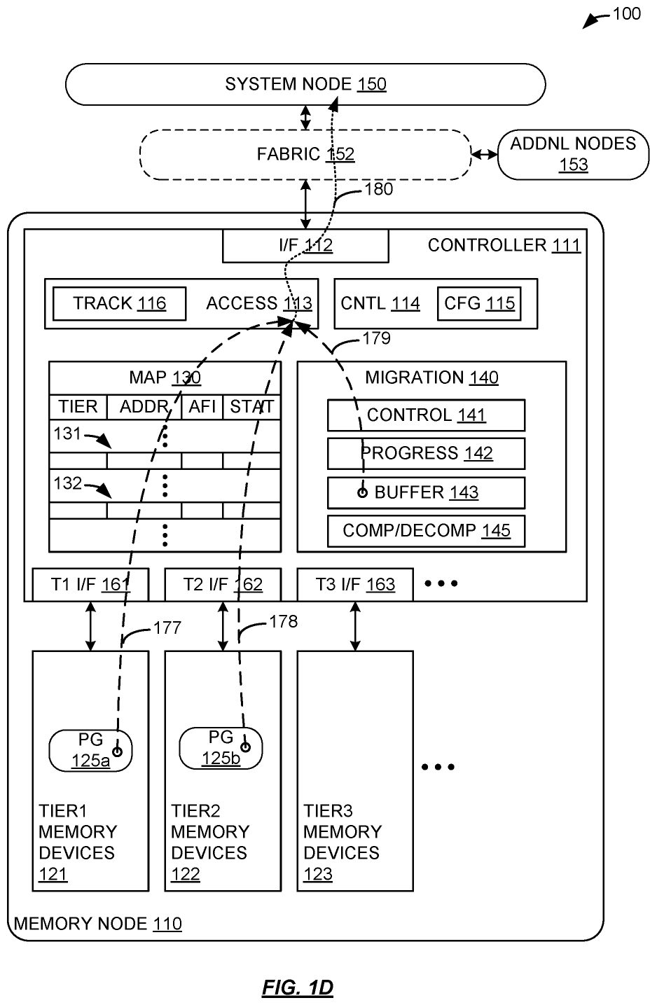

FIGS. 1A-1D are block diagrams illustrating an interconnected processing system with non-disruptive memory migration. In FIGS. 1A-1D, system 100 comprises system node 150, optional fabric 152, additional nodes 153, and memory node 110. Memory node 110 includes controller device 111, tier1 memory devices 121, tier2 memory devices 122, and tier3 memory device 123. Controller device 111 includes one or more system interfaces 112, access circuitry 113, control circuitry 114, map circuitry 130, migration circuitry 140, tier1 memory interface 161, tier2 memory interface 162, and tier3 memory interface 163. Control circuitry 114 includes configuration information 115. Access circuitry 113 includes access tracking circuitry 116. Map circuitry 130 includes circuitry (e.g., registers, memory, tables) storing a plurality of mapping entries 131-132. Mapping entries 131-132 stored in mapping circuitry 130 each include memory tier information, block physical address information, access frequency information, and status information. Migration circuitry includes control circuitry 141, progress checker circuitry 142, buffer 143, and compression/decompression circuitry 145. Buffer 143 may be configured, for example, to hold a cache line sized block of data (e.g., cache line size of system node 150 and/or system 100).

Tier1 memory devices 121 are operatively coupled to controller device 111 via tier1 memory interface 161. Tier2 memory devices 122 are operatively coupled to controller device 111 via tier2 memory interface 162. Tier2 memory devices 122 are operatively coupled to controller device 111 via tier2 memory interface 162. In an embodiment, tier1 memory devices 121, tier2 memory devices 122, and tier3 memory device 123 have different characteristics that separate tier1 memory devices 121, tier2 memory devices 122, and tier3 memory device 123 into their respective tiers. Characteristics that separate memory into tiers may include, for example, slow/fast/fastest, longer-latency/shorter-latency, local/remote, compressed/uncompressed, bandwidth, jitter, capacity, and persistence, or a combination thereof.

In an embodiment, at least two tiers of memory may be distinguished using compression (e.g., tier 1 memory devices 121 represent uncompressed memory and tier 2 memory devices 122 represent compressed memory). In this case, the compressed/uncompressed tiers may use same interface and/or devices. Accordingly, it should be understood that two or more of interfaces 161-163 in FIGS. 1A-1D may represent a single physical interface to a single set of memory devices storing both compressed and uncompressed data, or represent multiple interfaces to corresponding multiple sets of memory devices.

In some embodiments, system node 150, memory node 110, and additional nodes 153 may be operatively coupled to each other via fabric 152. Memory node 110 may be operatively coupled to fabric 152 via interface 112 of controller device 111. System node 150, memory node 110, and additional nodes 153 may be operatively coupled to fabric 152 to communicate and/or exchange information etc. with each other. Fabric 152 may be or comprise a switched fabric, point-to-point connections, and/or other interconnect architectures (e.g., ring topologies, crossbars, etc.). Fabric 152 may include links, linking, and/or protocols that are configured to be cache coherent. For example, fabric 152 may use links, linking, and/or protocols that include functionality described by and/or are compatible with one or more of Compute Express Link (CXL), Coherent Accelerator Processor Interface (CAPI), and Gen-Z standards, or the like.

In some embodiments, system node 150 and additional nodes 153 may be operatively coupled to each other and/or memory node 110 without using fabric 152. Thus, memory node 110 may be operatively coupled to system node 150 and/or additional nodes 153 via one or more interfaces 112.

In an embodiment, system node 150, memory node 110, and additional nodes 153 are operatively coupled to request and/or store information from/to that resides within other of system node 150, memory node 110, and/or additional nodes 153. In an embodiment, additional nodes 153 may include similar or the same elements as system node 150, and/or memory node 110 and are therefore, for the sake of brevity, not discussed further herein with reference to FIGS. 1A-1D.

In an embodiment, controller device 111 includes access circuitry 113. Access circuitry 113 is operatively coupled to tier1 memory devices 121, tier2 memory devices 122, and tier3 memory device 123. Access circuitry 113 is configured to access data (e.g., cache line sized data blocks) stored by at least one of tier1 memory devices 121, tier2 memory devices 122, and tier3 memory devices 123. Tracking circuitry 116 of access circuitry 113 monitors accesses. Tracking circuitry 116 monitors accesses to pages stored by at least one of tier1 memory devices 121, tier2 memory devices 122, and tier3 memory devices 123 to update and maintain the access frequency and/or recency information in mapping entries 131-132 associated with those pages. In an embodiment, controller device 111 may be, or comprise, a processor running a real-time operating system.

Memory node 110 (and controller device 111, in particular) is operatively coupled to fabric 152 to receive, from system node 150, access requests (e.g., reads and writes). Access requests transmitted by system node 150 may include read requests (e.g., to read a cache line sized block of data) and write requests (e.g., to write a cache line sized block of data). In an embodiment, to respond to a read or write request, controller device 111 may use an entry 131-132 in mapping circuitry 130 to relate the addressed received from system node 150 to a tier of memory devices 121-123 and a physical address that is used by respective memory devices 121-123 of that tier.

In FIG. 1B, page 125a resides in tier1 memory devices 121. In an embodiment, migration circuitry 140 of controller device 111 and memory node 110 may select page 125a to be migrated to tier2 memory devices 122. Migration circuitry 140 of controller device 111 and memory node 110 may select page 125a to be migrated to tier2 memory devices 122 based on an access frequency information (AFI) in a mapping entry 131 that corresponds to page 125a. This is illustrated in FIG. 1B by arrow 170 running from the access frequency information of mapping entry 131 to control circuitry 141 of migration circuitry 140.

Migration circuitry 140 (e.g., under the control of control circuitry 141) may then read the selected page 125a from tier1 memory devices 121 into buffer 143 and then copy the page 125a to tier2 memory devices 122 where the copy will reside as page 125b. This is illustrated in FIG. 1B by arrow 171 running from page 125a in tier1 memory devices 121 to buffer 143 in migration circuitry 140 and arrow 172 running from buffer 143 to page 125b in tier2 memory devices 122. Optionally, migration circuitry 140 may use compression/decompression circuitry 145 to compress page 125a before writing a compressed version to tier2 memory devices 122 as page 125b (not shown in FIG. 1B).

In an embodiment, system node 150 may send an access (i.e., read or write) request directed to an address associated with page 125a that is in the process of being migrated. This is illustrated in FIG. 1C by arrow 173 running from system node 150 through fabric 152 to access circuitry 113 in controller device 111 of memory node 110. In response to the access request, controller device 111 determines, using the status information in the mapping entry 131 that corresponds to page 125a, whether the page 125a being accessed is in the process of being migrated. This is illustrated in FIG. 1C by arrow 174 running from mapping entry 131 to access circuitry 113. If the page is being migrated, controller device 111, using progress checker circuitry 142 of migration circuitry 140, determines whether the access is directed to a portion of page 125a that has not yet been migrated, has already been migrated, or is currently residing in buffer 143. This is illustrated in FIG. 1C by arrow 175 running from access circuitry 113 to progress checker circuitry 142 and arrow 176 running from progress checker circuitry 142 to access circuitry 113.

If the access is addressed to a portion of page 125a that has not yet been migrated, the source memory tier (i.e., tier1 memory devices 121) are used to perform the access. This is illustrated in FIG. 1D by arrow 177 running from page 125a in tier1 memory devices 121 to access circuitry 113, and arrow 180 running from access circuitry 113 through fabric 152 to system node 150. If the access is addressed to a portion of page 125a that has already been migrated, the destination memory tier (i.e., tier2 memory devices 122) are used to perform the access. This is illustrated in FIG. 1D by arrow 178 running from page 125b in tier2 memory devices 122 to access circuitry 113, and arrow 180 running from access circuitry 113 through fabric 152 to system node 150. If the access is addressed to a portion of page 125a that currently resides in buffer 143 of migration circuitry 140, the buffer 143 is used to perform the access. This is illustrated in FIG. 1D by arrow 179 running from buffer 143 to access circuitry 113, and arrow 180 running from access circuitry 113 through fabric 152 to system node 150.

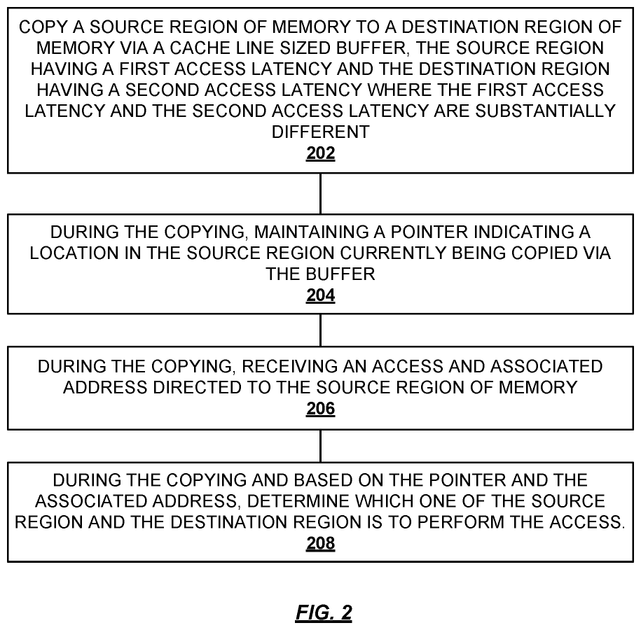

FIG. 2 is a flowchart illustrating a method of operating a controller. One or more of the steps illustrated in FIG. 2 may be performed by, for example, system 100 and/or its components. A source region of memory is copied to a destination region of memory via a cache line sized buffer, the source region having a first access latency and the destination region having a second access latency where the first access latency and the second access latency are substantially different (202). For example, controller device 111 (and migration circuitry 140, in particular) may copy, via buffer 143, page 125a from tier1 memory devices 121 to tier2 memory devices 122 where it will be stored as page 125b in tier2 memory devices 122, where tier1 memory devices 121 and tier2 memory devices have substantially different access latencies.

A pointer is maintained during the copying indicating a location in the source region currently being copied via the buffer (204). For example, progress checker circuitry 142 may maintain a pointer or counter corresponding to the location in page 125a in tier1 memory devices 121 that is currently being held by buffer 143. During the copying, an access and associated address directed to the source region of memory is received (206). For example, system node 150 may send an access (i.e., read or write) request directed to an address associated with page 125a that is in the process of being migrated.

During the copying and based on the pointer and the associated address, determine which one of the source region and the destination region is to perform the access (208). For example, in response to the access request, controller device 111 may determine, using progress checker circuitry 142 of migration circuitry 140, whether the access is directed to a portion of page 125a that has not yet been migrated or has already been migrated to page 125b.

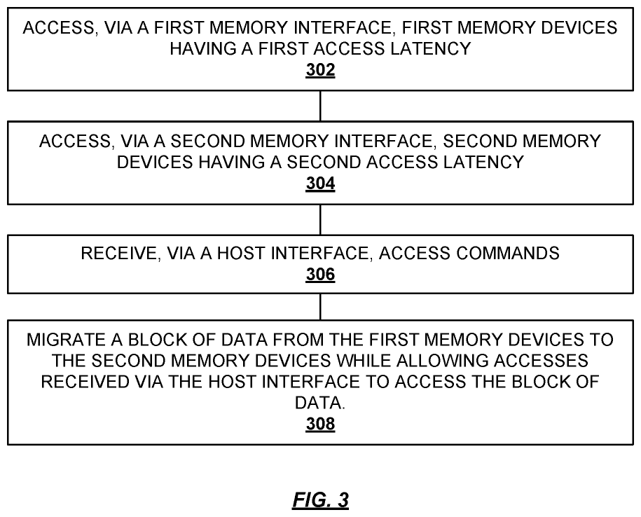

FIG. 3 is a flowchart illustrating a method of migrating data. One or more of the steps illustrated in FIG. 3 may be performed by, for example, system 100 and/or its components. Via a first memory interface, first memory devices having a first access latency are accessed (302). For example, via tier1 memory interface 161, tier1 memory devices 121 may be accessed by controller device 111, where tier1 memory devices 121 have a first access latency (302). Via a second memory interface, second memory devices having a second access latency are accessed (304). For example, via tier2 memory interface 162, tier2 memory devices 122 may be accessed by controller device 111, where tier2 memory devices 122 have a second access latency (304).

Via a host interface, access commands are received (306). For example, system node 150 may send access commands (i.e., read or write) directed to tier1 memory devices 121, tier2 memory devices 122, and/or tier3 memory devices 123.

A block of data is migrated from the first memory devices to the second memory device while allowing accesses received via the host interface to access the block of data (308). For example, while page 125a is being migrated to the tier2 memory device 122, system node 150 may issue access requests that may or may not be directed to one or more address associated with page 125a that is in the process of being migrated. In response to each access request, controller device 111 determines, using the status information in the mapping entry 131 that corresponds to page 125a, whether page 125a is being accessed and is in the process of being migrated. If the page is being migrated, controller device 111, using progress checker circuitry 142 of migration circuitry 140, determines whether the access is directed to a portion of page 125a that has not yet been migrated, has already been migrated, or is currently residing in buffer 143. If the access is addressed to a portion of page 125a that has not yet been migrated, the source memory tier (i.e., tier1 memory devices 121) are used to perform the access. If the access is addressed to a portion of page 125a that has already been migrated, the destination memory tier (i.e., tier2 memory devices 122) are used to perform the access. If the access is addressed to a portion of page 125a that currently resides in buffer 143 of migration circuitry 140, the buffer 143 is used to perform the access.

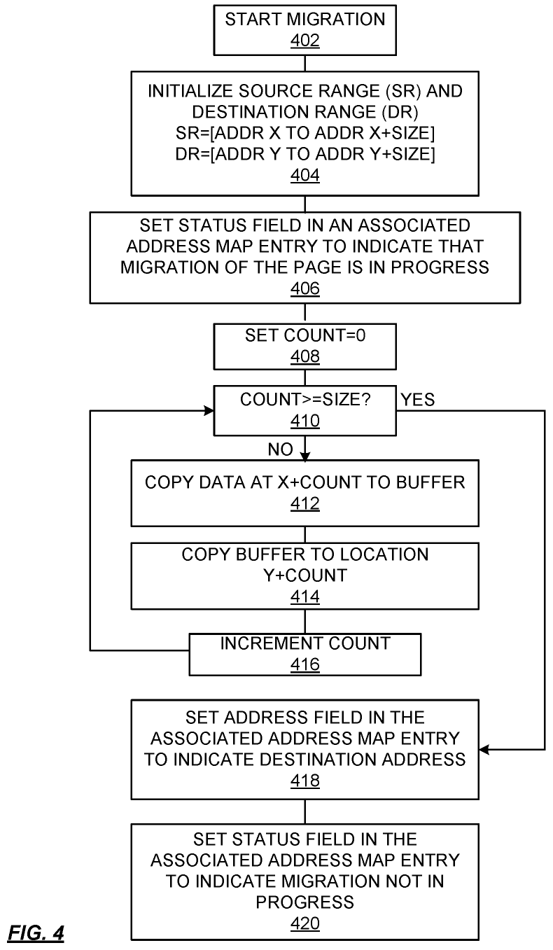

FIG. 4 is a flowchart illustrating a page migration method. One or more of the steps illustrated in FIG. 4 may be performed by, for example, system 100 and/or its components. A migration is started (402). For example, migration circuitry 140 of controller device 111 and memory node 110 may select page 125a in tier1 memory devices 121 to be migrated to tier2 memory devices 122. Migration circuitry 140 of controller device 111 and memory node 110 may select page 125a to be migrated to tier2 memory devices 122 based on an access frequency information in a mapping entry 131 that corresponds to page 125a.

A source range (SR) and destination range (DR) are initialized (404). For example, migration circuitry 140 may initialize the extents of page 125a in tier1 memory devices 121 as a source range for a migration and initialize the extents of page 125b in tier2 memory devices 122 as a destination range for the migration. A status field in an associated address map entry is set to indicate that migration of the page is in progress (406). For example, controller device 111 (and migration circuitry 140, in particular) may set the status field in mapping entry 131 of mapping circuitry 130 where mapping entry 131 is associated with page 125a (and, once the migration is complete, be associated with page 125b) to indicate page 125a is currently being migrated.

A count is set to zero (408). For example, a counter in migration circuitry 140 (and progress checker circuitry 142, in particular), may be set to an initial value. It is determined whether the count meets or exceeds the size of the block being migrated. If the count in progress checker circuitry 142 is less than the size of the block being migrated, flow proceeds to block 412. If the count is greater than or equal to the size of the block being migrated, flow proceeds to block 418. In block 412, the data in the source range at the current source range start plus current count is copied to a buffer (412). For example, migration circuitry 140 may copy a cache line pointed to by the start of page 125a plus the current count in progress checker circuitry 142 to buffer 143.

The buffer is copied to the location at the current destination range start plus current count (414). For example, migration circuitry 140 may copy the cache line from buffer 143 to the cache line location pointed to by the start of page 125b plus the current count in progress checker circuitry 142. The count is incremented (416) and flow then proceeds to box 410. For example, the current count in progress checker circuitry 142 may be incremented.

If the count is greater than or equal to the size of the block being migrated, flow proceeds to block 418. In block 418, the address field in the associated address map entry is set to indicate the destination address (418). For example, the address information in mapping entry 131 may be set to indicate page 125b in tier2 memory devices 122. The status field in the associated address map entry is set to indicate migration is not in progress (420). For example, controller device 111 (and migration circuitry 140, in particular) may set the status field in mapping entry 131 of mapping circuitry 130 to indicate that page 125b is not currently being migrated.

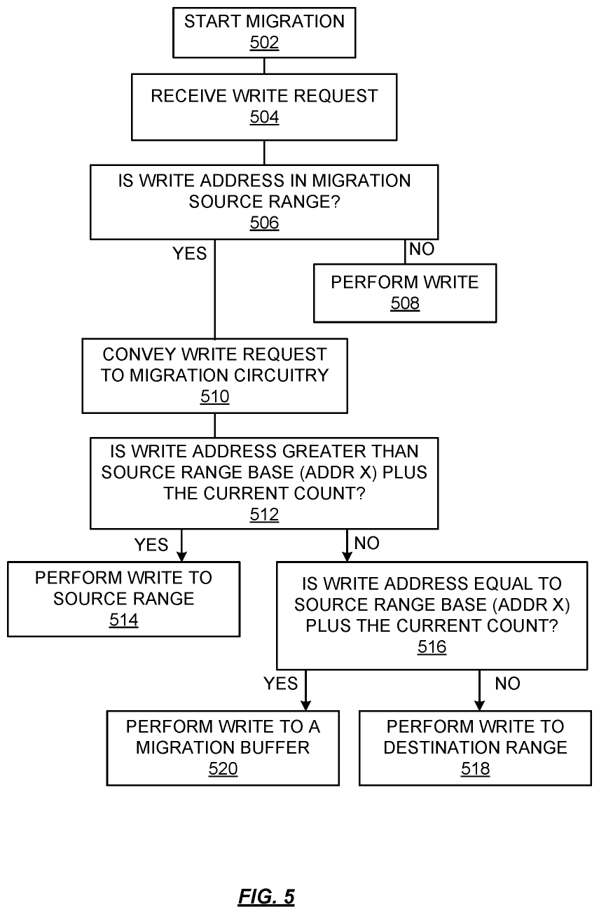

FIG. 5 is a flowchart illustrating a method of processing write requests. One or more of the steps illustrated in FIG. 5 may be performed by, for example, system 100 and/or its components. A migration is started (502). For example, migration circuitry 140 of controller device 111 and memory node 110 may select page 125a in tier1 memory devices 121 to be migrated to tier2 memory devices 122. Migration circuitry 140 of controller device 111 and memory node 110 may select page 125a to be migrated to tier2 memory devices 122 based on an access frequency information in a mapping entry 131 that corresponds to page 125a.

A write request is received (504). For example, system node 150 may transmit a write request directed to an address associated with memory node 110. It is determined whether the write address in in the migration source range (506). If the write address is not within the migration source range, flow proceeds to box 508. In box 508, the write is performed (508) For example, if the write request is not to a cache line within page 125a, access circuitry 113 may complete the write request without further involvement of migration circuitry 140. If the write address is within the migration source range, flow proceeds to box 510.

In box 510, the write request is conveyed to the migration circuitry (510). For example, in response to determining that the write request is to a cache line within page 125a, which is being migrated, access circuitry 113 may convey the write request to migration circuitry 140. It is determined whether the write address is greater than the source range base plus the current count (512). If the write address is greater than the source range base plus the current count, flow proceeds to box 514. In box 514, the write is performed to the source range (514). For example, if the write address is to a portion of page 125a that has not yet been migrated, migration circuitry 140 (and/or access circuitry 113) may perform the write request on page 125a. If the write address is not greater than the source range base plus the current count, flow proceeds to box 516. In box 516, it is determined whether the write address is equal to the source range base plus the current count (516). If the write address is not equal to the source range base plus the current count, flow proceeds to box 518. In box 518, the write is performed to the destination range (518). For example, if the write address is to a portion of page 125a that has already been migrated, migration circuitry 140 (and/or access circuitry 113) may perform the write request on page 125b. If the write address is equal to the source range base plus the current count, flow proceeds to box 520. In box 520, the write is performed to a migration buffer (520). For example, if the write address is to a portion of page 125a that is currently in buffer 143, migration circuitry 140 (and/or access circuitry 113) may perform the write request to buffer 143 before the contents of buffer 143 are written to page 125b.

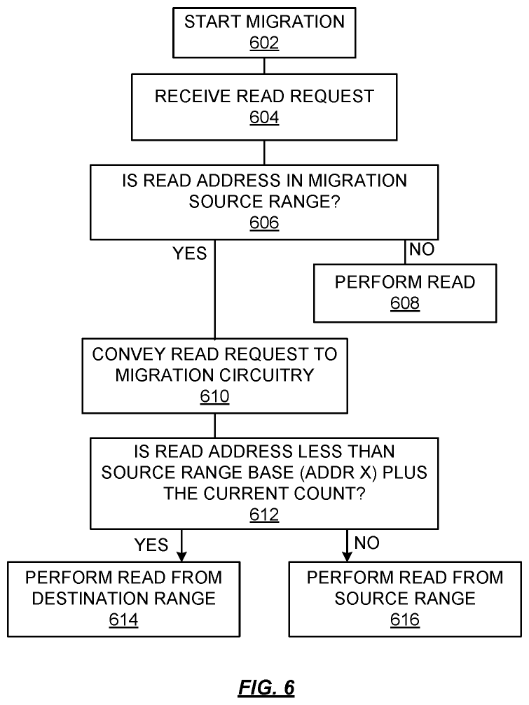

FIG. 6 is a flowchart illustrating a method of processing read requests. One or more of the steps illustrated in FIG. 6 may be performed by, for example, system 100 and/or its components. A migration is started (602). For example, migration circuitry 140 of controller device 111 and memory node 110 may select page 125a in tier1 memory devices 121 to be migrated to tier2 memory devices 122. Migration circuitry 140 of controller device 111 and memory node 110 may select page 125a to be migrated to tier2 memory devices 122 based on an access frequency information in a mapping entry 131 that corresponds to page 125a.

A read request is received (604). For example, system node 150 may transmit a read request directed to an address associated with memory node 110. It is determined whether the read address in in the migration source range (606). If the read address is not within the migration source range, flow proceeds to box 608. In box 608, the read is performed (508) For example, if the read request is not to a cache line within page 125a, access circuitry 113 may complete the read request without further involvement of migration circuitry 140. If the read address is within the migration source range, flow proceeds to box 610.

In box 610, the read request is conveyed to the migration circuitry (610). For example, in response to determining that the read request is to a cache line within page 125a, which is being migrated, access circuitry 113 may convey the read request to migration circuitry 140. It is determined whether the read address is less than the source range base plus the current count (612). If the read address is less than the source range base plus the current count, flow proceeds to box 614. In box 614, the read is performed from the source range (614). For example, if the read address is to a portion of page 125a that has been migrated, migration circuitry 140 (and/or access circuitry 113) may read from page 125a. If the read address is not less than the source range base plus the current count, flow proceeds to box 616. In box 616, the read is performed from the destination range (616). For example, if the read address is to a portion of page 125a that has already been migrated, migration circuitry 140 (and/or access circuitry 113) may read request from page 125b.

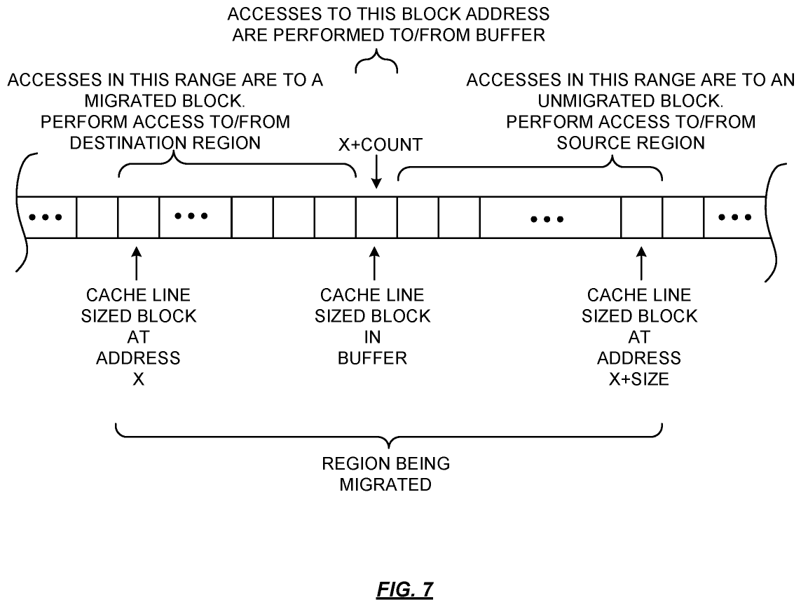

FIG. 7 is a notional diagram illustrating memory being migrated. In FIG. 7, memory block (e.g., cache line size blocks) are illustrated. FIG. 7 also illustrates a region of memory being migrated, the start of the region being migrated (at address “X”), the end of the region being migrated (at address X+size), and a pointer to the current block (or counter indexed to the block) being migrated (at address X+count).

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of memory system 100, and its components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

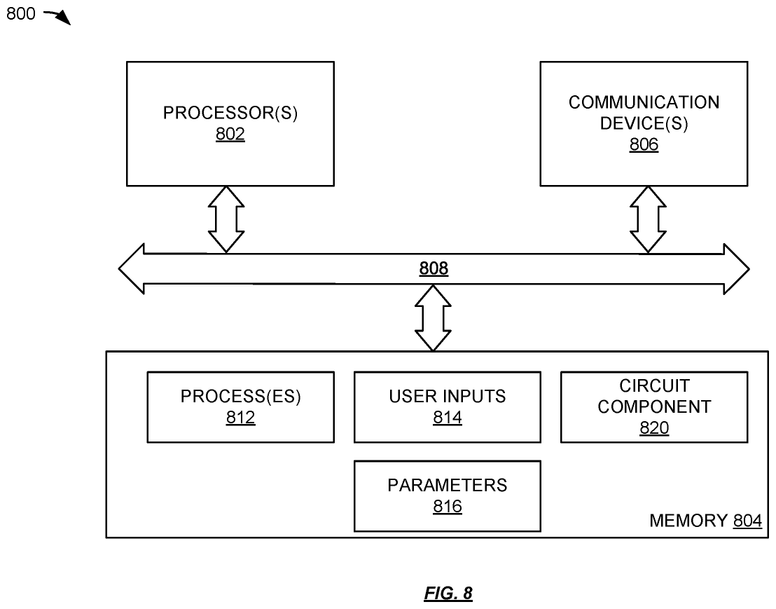

FIG. 8 is a block diagram illustrating one embodiment of a processing system 800 for including, processing, or generating, a representation of a circuit component 820. Processing system 800 includes one or more processors 802, a memory 804, and one or more communications devices 806. Processors 802, memory 804, and communications devices 806 communicate using any suitable type, number, and/or configuration of wired and/or wireless connections 808.

Processors 802 execute instructions of one or more processes 812 stored in a memory 804 to process and/or generate circuit component 820 responsive to user inputs 814 and parameters 816. Processes 812 may be any suitable electronic design automation (EDA) tool or portion thereof used to design, simulate, analyze, and/or verify electronic circuitry and/or generate photomasks for electronic circuitry. Representation 820 includes data that describes all or portions of memory system 100, and its components, as shown in the Figures.

Representation 820 may include one or more of behavioral, register transfer, logic component, transistor, and layout geometry-level descriptions. Moreover, representation 820 may be stored on storage media or communicated by carrier waves.

Data formats in which representation 820 may be implemented include, but are not limited to: formats supporting behavioral languages like C, formats supporting register transfer languages (such as GDSII, GDSIII, GDSIV, CIF, and MEBES), and other suitable formats and languages. Moreover, data transfers of such files on machine-readable media may be done electronically over the diverse media on the Internet or, for example, via email

User inputs 814 may comprise input parameters from a keyboard, mouse, voice recognition interface, microphone and speakers, graphical display, touch screen, or other type of user interface device. This user interface may be distributed among multiple interface devices. Parameters 816 may include specifications and/or characteristics that are input to help define representation 820. For example, parameters 816 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 804 includes any suitable type, number, and/or configuration of non-transitory computer-readable storage media that stores processes 812, user inputs 814, parameters 816, and circuit component 820.

Communications devices 806 include any suitable type, number, and/or configuration of wired and/or wireless devices that transmit information from processing system 800 to another processing or storage system (not shown) and/or receive information from another processing or storage system (not shown). For example, communications devices 806 may transmit circuit component 820 to another system. Communications devices 806 may receive processes 812, user inputs 814, parameters 816, and/or circuit component 820 and cause processes 812, user inputs 814, parameters 816, and/or circuit component 820 to be stored in memory 804.

Implementations discussed herein include, but are not limited to, the following examples:

Example 1: A controller, comprising: a first memory interface to access first memory devices having a first access latency; a second memory interface to access second memory devices having a second access latency; a host interface to receive access commands; and migration circuitry to migrate a block of data from the first memory devices to the second memory devices while allowing accesses received via the host interface to access the block of data.

Example 2: The controller of example 1, further comprising: address mapping circuitry to translate host addresses to addresses used by the first memory devices and the second memory devices.

Example 3: The controller of example 2, wherein the address mapping circuitry comprises: access tracking circuitry to maintain indicators of access frequency for a plurality of blocks of data.

Example 4: The controller of example 3, wherein the block of data is selected for migration from the first memory devices to the second memory devices based on at least one indicator of access frequency maintained by the access tracking circuitry.

Example 5: The controller of example 3, wherein the migration circuitry further comprises: a buffer to hold a portion of the block of data that is being migrated, the buffer responsive to accesses to the portion of the block of data.

Example 6: The controller of example 5, wherein the block of data corresponds to a page of data and the portion of the block of data corresponds to a cache line.

Example 7: The controller of example 1, wherein the migration circuitry further comprises: pointer circuitry to determine whether accesses to the block of data are accessing data that has been migrated to the second memory devices.

Example 8: A method of operating a controller, comprising: copying a source region of memory to a destination region of memory via a cache line sized buffer, the source region having a first access latency and the destination region having a second access latency where the first access latency and the second access latency are substantially different; during the copying, maintaining a pointer indicating a location in the source region currently being copied via the buffer; during the copying, receiving an access and associated address directed to the source region of memory; and during the copying and based on the pointer and the associated address, determine which one of the source region and the destination region is to perform the access.

Example 9: The method of example 8, further comprising: translating a host address to the associated address.

Example 10: The method of example 8, further comprising: maintaining indicators of access frequency for a plurality of blocks of data.

Example 11: The method of example 10, further comprising: selecting the source region based on an indicator of access frequency associated with the source region.

Example 12: The method of example 8, further comprising: compressing the source region into the destination region.

Example 13: The method of example 8, further comprising: decompressing the source region into the destination region.

Example 14: The method of example 8, wherein the second access latency is greater than the first access latency.

Example 15: A method of migrating data, comprising: accessing, via a first memory interface, first memory devices having a first access latency; accessing, via a second memory interface, second memory devices having a second access latency; receiving, via a host interface, access commands; and migrating a block of data from the first memory devices to the second memory devices while allowing accesses received via the host interface to access the block of data.

Example 16: The method of example 15, further comprising: translating host addresses to addresses used by the first memory devices and the second memory devices.

Example 17: The method of example 16, further comprising: maintaining indicators of access frequency for a plurality of blocks of data.

Example 18: The method of example 17, further comprising: selecting the block of data for migration from the first memory devices to the second memory devices based on at least one indicator of access frequency.

Example 19: The method of example 18, further comprising: holding a portion of the block of data that is being migrated in a buffer.

Example 20: The method of example 19, further comprising: responding to an access using the portion of the block of data in the buffer.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A controller, comprising:
a first memory interface to access first memory devices having a first access latency;
a second memory interface to access second memory devices having a second access latency;
a host interface to receive access commands; and
migration circuitry to migrate a block of data from the first memory devices to the second memory devices while allowing accesses received via the host interface to access the block of data.

2. The controller of claim 1, further comprising:
address mapping circuitry to translate host addresses to addresses used by the first memory devices and the second memory devices.

3. The controller of claim 2, wherein the address mapping circuitry comprises:
access tracking circuitry to maintain indicators of access frequency for a plurality of blocks of data.

4. The controller of claim 3, wherein the block of data is selected for migration from the first memory devices to the second memory devices based on at least one indicator of access frequency maintained by the access tracking circuitry.

5. The controller of claim 3, wherein the migration circuitry further comprises:
a buffer to hold a portion of the block of data that is being migrated, the buffer responsive to accesses to the portion of the block of data.

6. The controller of claim 5, wherein the block of data corresponds to a page of data and the portion of the block of data corresponds to a cache line.

7. The controller of claim 1, wherein the migration circuitry further comprises:
pointer circuitry to determine whether accesses to the block of data are accessing data that has been migrated to the second memory devices.

8. A method of operating a controller, comprising:
copying a source region of memory to a destination region of memory via a cache line sized buffer, the source region having a first access latency and the destination region having a second access latency where the first access latency and the second access latency are substantially different;
during the copying, maintaining a pointer indicating a location in the source region currently being copied via the buffer;
during the copying, receiving an access and associated address directed to the source region of memory; and
during the copying and based on the pointer and the associated address, determine which one of the source region and the destination region is to perform the access.

9. The method of claim 8, further comprising:
translating a host address to the associated address.

10. The method of claim 8, further comprising:
maintaining indicators of access frequency for a plurality of blocks of data.

11. The method of claim 10, further comprising:
selecting the source region based on an indicator of access frequency associated with the source region.

12. The method of claim 8, further comprising:
compressing the source region into the destination region.

13. The method of claim 8, further comprising:
decompressing the source region into the destination region.

14. The method of claim 8, wherein the second access latency is greater than the first access latency.

15. A method of migrating data, comprising:
accessing, via a first memory interface, first memory devices having a first access latency;
accessing, via a second memory interface, second memory devices having a second access latency;
receiving, via a host interface, access commands; and
migrating a block of data from the first memory devices to the second memory devices while allowing accesses received via the host interface to access the block of data.

16. The method of claim 15, further comprising:
translating host addresses to addresses used by the first memory devices and the second memory devices.

17. The method of claim 16, further comprising:
maintaining indicators of access frequency for a plurality of blocks of data.

18. The method of claim 17, further comprising:
selecting the block of data for migration from the first memory devices to the second memory devices based on at least one indicator of access frequency.

19. The method of claim 18, further comprising:
holding a portion of the block of data that is being migrated in a buffer.

20. The method of claim 19, further comprising:
responding to an access using the portion of the block of data in the buffer.
